(19) United States
(12) Patent Application Publication
(10) Pub. No.: US 2025/0373805 A1
(43) Pub. Date: Dec. 4, 2025

(54) DECODER QUANTIZATION SHIFTING OFFSET DERIVATION

(71) Applicant: Tencent America LLC, Palo Alto, CA (US)

(72) Inventors: Motong XU, Palo Alto, CA (US); Roman CHERNYAK, Santa Clara, CA (US); Biao WANG, San Jose, CA (US); Lien-Fei CHEN, Palo Alto, CA (US); Yonguk YOON, Palo Alto, CA (US); Ziyue XIANG, Palo Alto, CA (US); Minhao TANG, Palo Alto, CA (US); Shan LIU, San Jose, CA (US)

(73) Assignee: Tencent America LLC, Palo Alto, CA (US)

(21) Appl. No.: 19/301,915

(22) Filed: Aug. 15, 2025

Related U.S. Application Data
(63) Continuation of application No. PCT/US2024/031637, filed on May 30, 2024.
(60) Provisional application No. 63/605,333, filed on Dec. 1, 2023.

(51) Int. Cl. H04N 19/124; H04N 19/105; H04N 19/159; H04N 19/176

(52) U.S. Cl. CPC H04N 19/124; H04N 19/105; H04N 19/159; H04N 19/176

(57) ABSTRACT

Processing circuitry performs a dequantization on a first quantized block that is decoded from the coded information of the current block to generate a dequantized block. The processing circuitry performs an inverse transform on the dequantized block to obtain an inverse transform block, combines the first predictor of the current block with the inverse transform block of the dequantized block to generate an intermediate reconstruction of the current block, generates a second predictor of the current block based on one or more neighboring blocks of the current block, performs a transform on a difference of the intermediate reconstruction of the current block and the second predictor of the current block to generate a transform block, performs a quantization on the transform block to generate a second quantized block, and determines at least a quantization shifting offset based on the dequantized block and the second quantized block.

### INCORPORATION BY REFERENCE

The present application is a continuation of International Application No. PCT/US2024/031637, entitled “DECODER QUANTIZATION SHIFTING OFFSET DERIVATION” and filed on May 30, 2024, which claims the benefit of priority to U.S. Provisional Application No. 63/605,333, “DECODER QUANTIZATION SHIFTING OFFSET DERIVATION” filed on Dec. 1, 2023. The entire disclosures of the prior applications are hereby incorporated by reference.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include bitstreams, methods and apparatuses for video encoding/decoding. In some examples, an apparatus for video encoding/decoding includes processing circuitry.

Some aspects of the disclosure provide a method of processing visual media data. The method includes processing a bitstream of visual media data according to a format rule. The bitstream includes coded information of a current block, the coded information of the current block is indicative of a first predictor of the current block and includes coded bits for a first quantized block in a frequency domain associated with a residual block of the current block to the first predictor. The format rule specifies that a dequantization is performed on the first quantized block to generate a dequantized block, an inverse transform is performed on the dequantized block to obtain an inverse transform block, the first predictor of the current block is combined with the inverse transform block of the dequantized block to generate an intermediate reconstruction of the current block, a second predictor of the current block is generated based on one or more neighboring blocks of the current block, a transform is performed on a difference of the intermediate reconstruction of the current block and the second predictor of the current block to generate a transform block, a quantization is performed on the transform block to generate a second quantized block, the first quantized block and the second quantized block having a same quantization step size, at least a quantization shifting offset is determined based on the dequantized block and the second quantized block, the dequantized block is adjusted based on at least the quantization shifting offset to generate updated dequantized block, and the current block is reconstructed based on the updated dequantized block.

Some aspects of the disclosure provide an apparatus for video decoding. The apparatus includes processing circuitry configured to receive a bitstream that comprises coded information of a current block, the coded information of the current block is indicative of a first predictor of the current block and the coded information of the current block includes coded bits for a first quantized block in a frequency domain associated with a residual block in a spatial domain for the first predictor of the current block. The processing circuitry is further configured to perform a dequantization on the first quantized block that is decoded from the coded information of the current block to generate a dequantized block, perform an inverse transform on the dequantized block to obtain an inverse transform block, combine the first predictor of the current block with the inverse transform block of the dequantized block to generate an intermediate reconstruction of the current block, generate a second predictor of the current block based on one or more neighboring blocks of the current block, perform a transform on a difference of the intermediate reconstruction of the current block and the second predictor of the current block to generate a transform block, perform a quantization on the transform block to generate a second quantized block, determine at least a quantization shifting offset based on the dequantized block and the second quantized block, adjust the dequantized block based on at least the quantization shifting offset to generate updated dequantized block, and reconstruct the current block based on the updated dequantized block.

In some examples, the first quantized block and the second quantized block have a same quantization step size.

In some examples, the processing circuitry is configured to generate the second predictor of the current block based on prediction information of a neighboring block that is above the current block. In some examples, the processing circuitry is configured to generate the second predictor of the current block based on prediction information of a neighboring block that is left to the current block.

In some examples, the processing circuitry is configured to generate a plurality of component predictors of the current block respectively based on a plurality of neighboring blocks of the current block, and determine the second predictor based on the plurality of component predictors. In an example, the processing circuitry is configured to generate the second predictor as an average of the plurality of component predictors. In another example, the processing circuitry is configured to generate the second predictor as a weighted average of the plurality of component predictors. For example, the processing circuitry is configured to weight a specific component predictor that is generated based on a specific neighboring block of the current block based on a distance between the specific neighboring block and the current block.

In some examples, the processing circuitry is configured to determine a plurality of component quantization shifting offsets respectively associated with a plurality of neighboring blocks of the current block and calculate the quantization shifting offset as an average of the plurality of component quantization shifting offsets.

In some examples, the processing circuitry is configured to determine a plurality of component quantization shifting offsets respectively associated with a plurality of neighboring blocks of the current block, and calculate the quantization shifting offset as a weighted average of the plurality of component quantization shifting offsets. In an example, the processing circuitry is configured to weight a specific component quantization shifting offset in the plurality of component quantization shifting offsets associated with a specific neighboring block of the current block based on a distance between the specific neighboring block and the current block.

In some examples, the processing circuitry is configured to derive an intra mode for the current block based on reconstructed samples in the one or more neighboring blocks of the current block, and generate the second predictor of the current block according to the intra mode.

In some examples, the processing circuitry is configured to when the first predictor of the current block is predicted from an intra prediction, generate the second predictor using a different intra mode from the first predictor. In an example, the transform is of a same type as an encoder side transform that is applied on the residual block to transform the residual block from the spatial domain to the frequency domain. In another example, the transform is of a different type from an encoder side transform that is applied on the residual block to transform the residual block from the spatial domain to the frequency domain.

In some examples, the processing circuitry is configured to perform the quantization that is a rate distortion optimization (RDO) based quantizer on the transform block to generate a second quantized block.

In some examples, the processing circuitry is configured to determine a block level quantization shifting offset according to one or more quantization shifting offsets for one or more coefficients in the transform block, and adjust one or more coefficients of the dequantized block based on the block level quantization shifting offset to generate updated dequantized block.

In some examples, the processing circuitry is configured to apply a filter on the intermediate reconstruction of the current block before using the intermediate reconstruction for a further processing.

Some aspects of the disclosure provide a method for video encoding. The method includes determining to use a decoder quantization shifting offset derivation for encoding a current block, generating a first predictor for the current block, calculating a residual block between the current block and the first predictor, performing a first transform on the residual block to generate a first transform block in a frequency domain, performing a first quantization on the first transform block to generate a first quantized block, encoding the current block based on the first quantized block, performing a dequantization on the first quantized block to generate a dequantized block, performing an inverse transform on the dequantized block to obtain an inverse transform block, combining the first predictor of the current block with the inverse transform block of the dequantized block to generate an intermediate reconstruction of the current block, generating a second predictor of the current block based on one or more neighboring blocks of the current block, performing a second transform on a difference of the intermediate reconstruction of the current block and the second predictor of the current block to generate a second transform block, performing a second quantization on the second transform block to generate a second quantized block, the second quantization having a same quantization step size as the first quantization, determining at least a quantization shifting offset based on the dequantized block and the second quantized block, adjusting the dequantized block based on at least the quantization shifting offset to generate updated dequantized block and reconstructing the current block based on the updated dequantized block.

Aspects of the disclosure also provide an apparatus for video encoding. The apparatus for video encoding including processing circuitry configured to implement any of the described methods for video encoding.

Aspects of the disclosure also provide a method for video decoding. The method including any of the methods implemented by the apparatus for video decoding.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system (100).

FIG. 2 is a schematic illustration of an example of a block diagram of a decoder.

FIG. 3 is a schematic illustration of an example of a block diagram of an encoder.

FIG. 4 shows a flow chart outlining a decoding process according to some aspects of the disclosure.

FIG. 5 shows a flow chart outlining an encoding process according to some aspects of the disclosure.

FIG. 6 is a schematic illustration of a computer system in accordance with an aspect.

### DETAILED DESCRIPTION

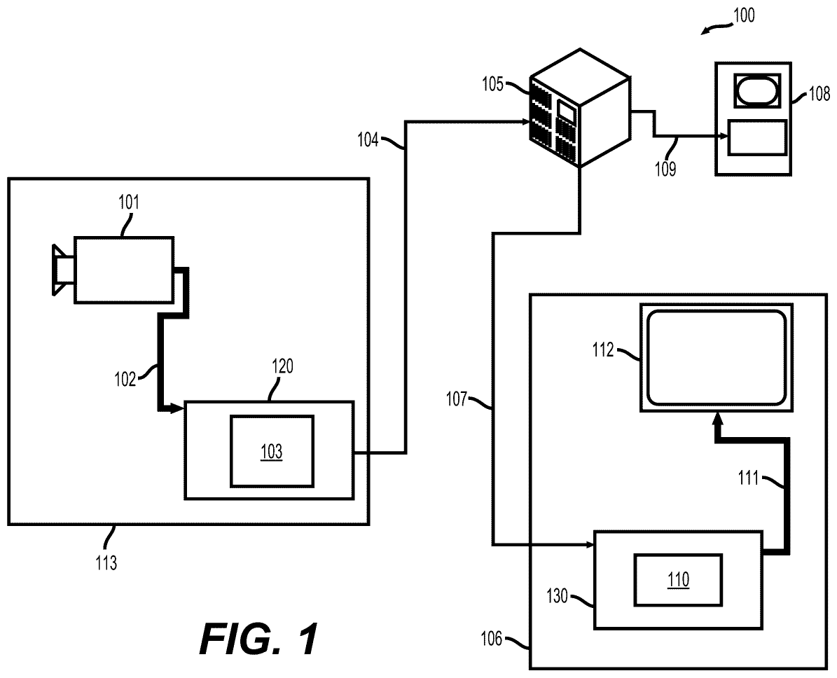

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

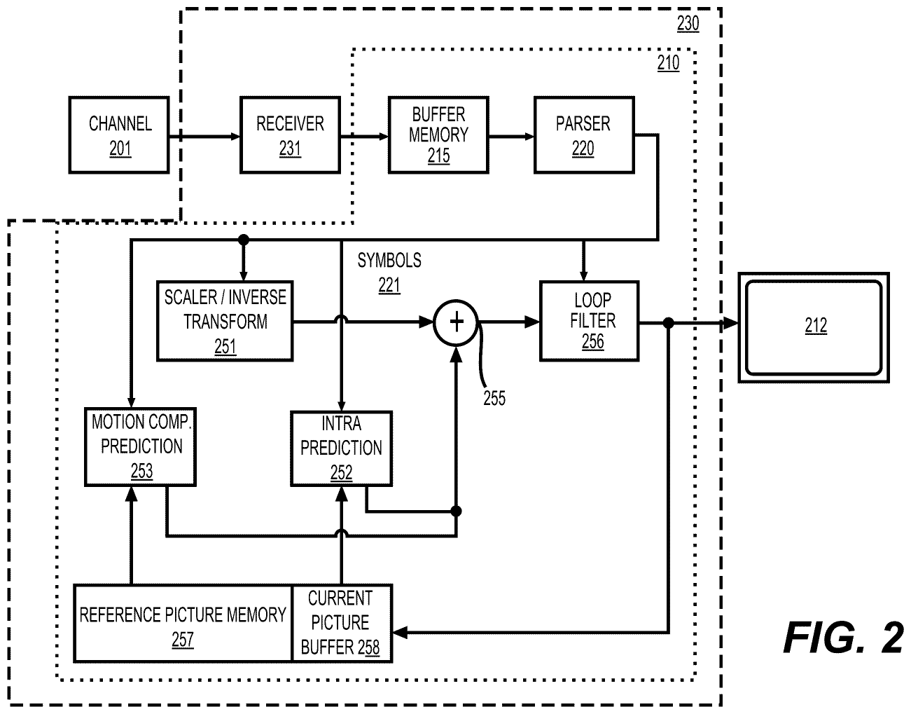

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

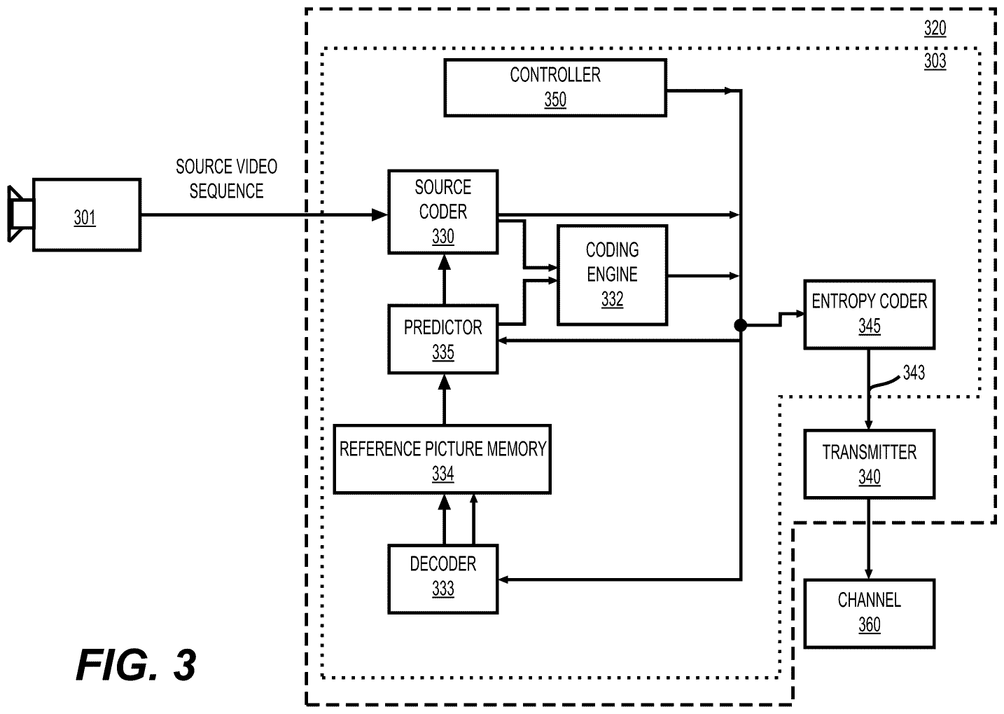

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some examples, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Aspects of the disclosure provide techniques for decoder side quantization shifting offset prediction. The techniques are used for predicting the quantization shifting offset at the decoder side for image and video coding in some examples, and can achieve image quality improvement.

In video codec, techniques, such as transform, quantization, and the like are used to reduce redundancy in video signals. For example, transform techniques can reduce redundancy in the video signal by decorrelation, and quantization techniques can decrease the data of the transform coefficient representation by reducing precision, for example by removing only imperceptible details, and thus reducing irrelevance in the data.

In some examples, transformation decorrelates a signal by transforming the signal from the spatial domain to a transform domain (typically a frequency domain), using a suitable transform basis. For example, a transform is applied to the prediction residual (regardless of whether it comes from inter- or intra-picture prediction), that is, the difference between the prediction and the original input video signal. In the transform domain, the essential information typically concentrates into a small number of coefficients. At the decoder, the inverse transform needs to be applied to reconstruct the residual samples.

Generally, quantization is used to reduce the precision of an input value or a set of input values in order to decrease the amount of data needed to represent the values. In some examples, the quantization is typically applied to individual transformed residual samples (e.g., transform coefficients), resulting in integer coefficient levels. The transform process is applied at the encoder. At the decoder, the corresponding process is known as inverse quantization (also referred to as dequantization) or simply as scaling, which restores the original value range without regaining the precision.

In some related video and image codecs, a quantization shifting offset ρ* that is predefined can be applied on the dequantized values at the decoder side. In some examples, the quantization shifting offset ρ* can be used to control a quantization dead zone.

In some related examples, at the decoder side, the reconstructed transform coefficient value yᵢ is generated by shifting the dequantized values dqᵢ (e.g., result from inverse quantization or scaling) within a dequantized block (in the transform domain also referred to as frequency domain) with the predefined quantization shifting offset ρ*, such as according to Eq. (1):

$$\{ \begin{matrix}{y}_{i} ← {dq}_{i} + {ρ}^{*} & when {dq}_{i} > 0 \\ {y}_{i} ← {dq}_{i} - {ρ}^{*} & when {dq}_{i} < 0 \\ {y}_{i} ← {dq}_{i} & when {dq}_{i} = 0\end{matrix} , for i = 1 … n \qquad Eq . ( 1 )$$

According to an aspect of the disclosure, the quantization shifting offset can be image content details dependent, and the present disclosure provides techniques to derive the quantization shifting offset at the decoder side and improve image quality. The techniques are referred to as decoder quantization shifting offset derivation techniques. In some examples, the decoder quantization shifting offset derivation techniques can derive the quantization shifting offset(s) for a current block based on an original predictor of the current block and a new predictor that is generated based on neighboring blocks. For example, encoder/decoder can perform a dequantization on a first quantized block to generate a dequantized block, perform an inverse transform on the dequantized block to obtain an inverse transform block, combine the first predictor of the current block with the inverse transform block of the dequantized block to generate an intermediate reconstruction of the current block, generate a second predictor of the current block based on one or more neighboring blocks of the current block, perform a transform on a difference of the intermediate reconstruction of the current block and the second predictor of the current block to generate a transform block, perform a quantization on the transform block to generate a second quantized block and determine at least a quantization shifting offset based on the dequantized block and the second quantized block, and adjust the dequantized block based on at least the quantization shifting offset to generate updated dequantized block.

In some examples, the original predictor (also referred to as the first predictor) of the current block is denoted by pred, and the new predictor (also referred to as the second predictor) is denoted by pred′. A first reconstructed block (also referred to as intermediate reconstruction of the current block in some examples) denoted by rec in the spatial domain is generated based on the original predictor pred and a first dequantized block denoted by dq, for example according to Eq. (2):

$$rec = {T}^{- 1} ( dq ) + pred \qquad Eq . ( 2 )$$

where the first dequantized block dq is the original received dequantized block (e.g., based on received coded bits of quantized block in the bitstream that are processed by the dequantization, such as multiplying with the quantization step). It is noted that T(⋅) denotes the operator of the original transform (also referred to as first transform), and T⁻¹(⋅) denotes the operator of the original inverse transform (also referred to as first inverse transform).

Further, a second dequantized block dq′ is generated at the decoder side, for example according to Eq. (3):

$${dq}^{′} = {T}^{′} ( rec - {pred}^{′} ) \qquad Eq . ( 3 )$$

where T′(⋅) denotes the operator of a second transform which can be the same as or can be different from the original transform T(⋅), and T′⁻¹(⋅) denotes the operator of second inverse transform which can be the same as or different from the original inverse transform T⁻¹(⋅).

In some examples, the quantization shifting offset(s) can be determined based on the first dequantized block dq and the second dequantized block dq′.

In an example, a second quantization that is also referred to as decoder-side quantization denoted by Q′(⋅) (with the same quantization step size Δ as the original quantization at the encoder-side) is applied to the second dequantized block dq′ to obtain the re-quantized block q′ (also referred to as second quantized block), such as represented by Eq. (4):

$${q}^{′} = {Q}^{′} ( {dq}^{′} ) \qquad Eq . ( 4 )$$

where Q′(⋅) is the operator of the second quantization which can be the same as or different from the original quantization Q(⋅) but with the same quantization step size.

In an example, for a transform coefficient (e.g., with index i) of the current block, the quantization shifting offset

$${ρ}_{i}^{*}$$

is derived according to Eq. (5):

$${ρ}_{i}^{*} = \{ \begin{matrix}\vert {dq}_{i} \vert - \vert {q}_{i}^{′} \vert \cdot Δ & when {dq}_{i} \neq 0 \\ 0 & when {dq}_{i} = 0\end{matrix} \qquad Eq . ( 5 )$$

where Δ denotes the quantization step size.

In another example, the quantization shifting offset ρ*ᵢ for a transform coefficient (e.g., of index i) of the current block is derived according to Eq. (6)

$${ρ}_{i}^{*} = \{ \begin{matrix}a & when \vert {dq}_{i} \vert - \vert {q}_{i}^{′} \vert \cdot Δ \geq 0 and {dq}_{i} \neq 0 \\ - a & when \vert {dq}_{i} \vert - \vert {q}_{i}^{′} \vert \cdot Δ < 0 and {dq}_{i} \neq 0 \\ 0 & when {q}_{i} = 0\end{matrix} \qquad Eq . ( 6 )$$

where α is a positive value that is predefined or signaled in the bitstream for the whole sequence/picture/slice/tile/block etc.

According to some aspects of the disclosure, the quantization shifting offset

$${ρ}_{i}^{*}$$

is derived at decoder side from the original dequantized block dq and a re-quantized block q′ for example according Eq. (5) and Eq. (6). The re-quantized block q′ can be obtained by various techniques, and some techniques are described with more details in the following description.

According to some aspects of the disclosure, the new predictor pred′ is generated using prediction information, such as prediction mode from the neighboring blocks. In some examples, the same prediction information (e.g., an inter prediction mode, motion information, reference picture information and the like) as one or more neighboring blocks can be used to generate the new predictor pred′.

In some examples, the new predictor pred′ is generated by applying the same prediction mode from the already reconstructed block above the current block. In some examples, the new predictor pred′ is generated based on the same motion information from the already reconstructed block above the current block. For example, the same motion information from the already reconstructed block above the current block is used to generate a new inter prediction block of the current block. The new inter prediction block of the current block is used as the new predictor pred′.

In some examples, the new predictor pred′ is generated by applying the same prediction mode from the already reconstructed block to the left of the current block. In some examples, the new predictor pred′ is generated based on the same motion information from the already reconstructed block to the left of the current block. For example, the same motion information from the left neighboring block of the current block is used to generate a new inter prediction block of the current block. The new inter prediction block of the current block is then used as the new predictor pred′.

In some examples, n new predictors (also referred to as n component new predictors, n is a positive integer that is larger than 1) are generated by respectively applying the same prediction modes as n already reconstructed neighboring blocks. Further, the new predictor pred′ is a combined new predictor that is calculated from these n component new predictors. The quantization shifting offset(s) is calculated based on the combined new predictor.

In some examples, a first component new predictor

$${pred}_{left}^{′}$$

is generated by applying the same prediction mode of the left neighboring block, and a second component new predictor

$${pred}_{above}^{′}$$

is generated by applying the same prediction mode of the above neighboring block. The combined new predictor pred′ is calculated as an average of two component new predictors, such as according to Eq. (7):

$${pred}^{′} = \frac{{pred}_{left}^{′} + {pred}_{right}^{′}}{2} \qquad Eq . ( 7 )$$

In some examples, the combined new predictor pred′ is calculated as the weighted average of n component new predictors, such as according to Eq. (8):

$${pred}^{′} = \frac{{\sum }_{j = 1}^{n} {w}_{j} \cdot {pred}_{j}^{′}}{n} \qquad Eq . ( 8 )$$

where pred′ⱼ denotes the component new predictor generated from the j-th neighboring block, and wⱼ denotes the corresponding weight. In an example, wⱼ depends on the distance between the j-th neighboring block and the current block.

In some examples, n component new predictors are generated by applying the prediction mode (e.g., motion information and residual information) from n already reconstructed neighboring blocks, and n quantization shifting offsets (also referred to as component quantization shifting offsets) are calculated respectively based on the n component new predictors. Then, the final quantization shifting offset which is a combined quantization shifting offset can be calculated as a combination of the n component

quantization shifting offsets, such as according to Eq. (9):

$${ρ}_{i}^{*} = \frac{{\sum }_{j = 1}^{n} {w}_{j} \cdot {ρ}_{i , j}^{*}}{n} \qquad Eq . ( 9 )$$

where

$${ρ}_{i , j}^{*}$$

denotes the component quantization shifting offset generated from the j-th component new predictor according to for example Eq. (5) or Eq. (6), and wⱼ is its corresponding weight. In an example, wⱼ depends on the distance between the j-th neighboring block and the current block.

In an example, two component new predictors

$${pred}_{left}^{′} and {pred}_{above}^{′}$$

are respectively generated by applying the same prediction mode of the left and above neighboring blocks. The two component quantization shifting offsets

$${ρ}_{i , left}^{*} and {ρ}_{i , above}^{*}$$

are respectively generated based on the component new predictors

$${pred}_{left}^{′} and {pred}_{above}^{′} ,$$

such as according to Eq. (5) or Eq. (6). The combined quantization shifting offset is calculated as Eq. (10):

$${ρ}_{i}^{*} = \frac{{ρ}_{i , left}^{*} + {ρ}_{i , above}^{*}}{2} \qquad Eq . ( 10 )$$

According to an aspect of the disclosure, an intra mode derivation technique, such as decoder-side intra mode derivation, template-based intra mode derivation and the like can be used to generate the new predictor pred′, no matter the current block is in an intra prediction mode or an inter prediction mode. In some examples, the decoder side intra mode derivation can generate a prediction based on texture analysis in a template region. In an example, three rows above the current template and/or three columns left to the current block are used to estimate angle gradient, and an intra prediction mode can be selected based on the estimated angle gradient. The intra prediction mode can be used to generate the new predictor pred′.

According to an aspect of the disclosure, when the original predictor of the current block is intra predicted, a new predictor pred′ is generated by a different intra prediction mode. The mode index of the different intra prediction mode can be predefined or can be signaled in the bitstream for the whole sequence/picture/slice/tile/block and the like.

In some examples, when the original predictor of the current block is predicted by an angular mode m, the new predictor pred′ is predicted by another angular mode m+k, where k is a nonzero integer that is either positive or negative. In an example, pred′ is predicted using angular mode m+1. In another example, pred′ is predicted using angular mode m−1.

In some examples, when the original predictor of the current block is predicted by an angular mode m, l new predictors

$${pred}_{1}^{′} , … , {pred}_{l}^{′}$$

are respectively predicted by angular modes m+k to m+k+l−1, where k is a nonzero integer that is either positive or negative.

In an example, the original predictor of the current block is predicted by an angular mode m, 2 new predictors pred₁′ and pred₂′ are predicted using angular mode m+1 and m−1, respectively. The final new predictor is obtained as Eq. (11) in an example:

$${pred}^{′} = \frac{{pred}_{1}^{′} + {pred}_{2}^{′}}{2} \qquad Eq . ( 11 )$$

In another example, the original predictor of the current block is predicted by an angular mode m, 2 new predictors pred₁′ and pred₂′ are predicted using angular mode m+1 and m−1, respectively. The quantization shifting offset is calculated as Eq. (12):

$${ρ}_{i}^{*} = \frac{{ρ}_{i , 1}^{*} + {ρ}_{i , 2}^{*}}{2} \qquad Eq . ( 12 )$$

where

$${ρ}_{i , 1}^{*} and {ρ}_{i , 2}^{*}$$

denotes the quantization shifting offsets generated from pred₁′ and pred₂′, respectively.

In some examples, the same transform and inverse transform type and combinations (including separable and/or non-separable primary/secondary transform(s)) as at the regular encoder and decoder side transform(s) is applied.

In some examples, the transform and inverse transform applied in Eq. (2) and Eq. (3) are independent from the transform at the encoder side. The transform type is predefined or signaled in the bitstream for the whole sequence/picture/slice/tile/block etc. In an example, DCT2 and a low-frequency non-separable secondary transform kernels and their corresponding inverse transforms are used for Eq. (2) and Eq. (3) irrespective of the regular encoder and decoder transform type(s). In another example, decoder reads the transform(s) type syntax from the bitstream and employs the corresponding transform(s) and inverse transform(s) kernels for Eq. (2) and Eq. (3).

According to an aspect of the disclosure, an RDO-based quantizer is used as Q′(⋅) in Eq. (4) to obtain the re-quantized block q′. In an example, the RDO-based quantizer can be encoder decided RDO-based quantizer, and can be signaled in the bitstream. In another example, the RDO-based quantizer can be decoder decided. In another example, the RDO-based quantizer can be predetermined. In an example, a rate-distortion optimized quantization is applied as Q′(⋅). In another example, a trellis coded quantization is applied as Q′(⋅). In another example, a dependent quantization is applied as Q′(⋅).

According to another aspect of the disclosure, the quantization shifting offset value (or its sign) is decided at block level based on all or a subset of the ρ*ᵢ values in the block, and referred to as block-level quantization shifting offset ρ*. The block-level quantization shifting offset ρ* of the block is applied to all or a subset of the coefficients in the block. In some examples, the block-level quantization shifting offset ρ* is derived based on all the

$${ρ}_{i}^{*}$$

value for each coefficient in the block. ρ* is used for all or a subset of the coefficients in the block, and the rest of the coefficients in the block can apply a fixed offset a (either positive or negative), where a is a value that is predefined or signaled in the bitstream for the whole sequence/picture/slice/tile/block etc.

In some examples, the block-level quantization shifting offset ρ* of the M×N block is calculated as Eq. (13):

$${ρ}^{*} = \frac{{\sum }_{i = 0}^{M \times N - 1} {ρ}_{i}^{*}}{M \times N} \qquad Eq . ( 13 )$$

In another example, the block-level quantization shifting offset ρ* of the M×N block is calculated according to a subset of the coefficients in the block as Eq. (14):

$${ρ}^{*} = \frac{{\sum }_{i = 0}^{m \times n - 1} {ρ}_{i}^{*}}{m \times n} \qquad Eq . ( 14 )$$

where 0<m<M and 0<n<N.

In another example, the block-level quantization shifting offset ρ* of the M×N block is decided as Eq. (15):

$${ρ}_{i}^{*} = \{ \begin{matrix}a & when S \geq 0 and {y}_{i} \neq 0 \\ - a & when S < 0 and {y}_{i} \neq 0 \\ 0 & when {y}_{i} = 0\end{matrix} \qquad Eq . ( 15 )$$

where a is a positive value that is predefined or signaled in the bitstream for the whole sequence/picture/slice/tile/block etc., and S is sum of all/a subset of the

$${ρ}_{i}^{*}$$

of the current block calculated as Eq. (16):

$$S = {\sum }_{i = 0}^{m \times n - 1} {ρ}_{i}^{*} \qquad Eq . ( 16 )$$

where 0<m≤M and 0<n≤N.

According to an aspect of the disclosure, a filter is applied to rec before generating the new dequantized block dq′. In an example, the new reconstructed block dq′ is obtained as Eq. (17):

$${dq}^{′} = {T}^{′} ( F ( rec ) - {pred}^{′} ) \qquad Eq . ( 17 )$$

where F(⋅) denotes filtering operator.

In another example, the new reconstructed block dq′ is obtained as Eq. (18):

$${dq}^{′} = {T}^{′} ( F ( rec - {pred}^{′} ) ) \qquad Eq . ( 18 )$$

In another example, the new reconstructed block dq′ is obtained as Eq. (19):

$${dq}^{′} = {T}^{′} ( rec - F ( {pred}^{′} ) ) \qquad Eq . ( 19 )$$

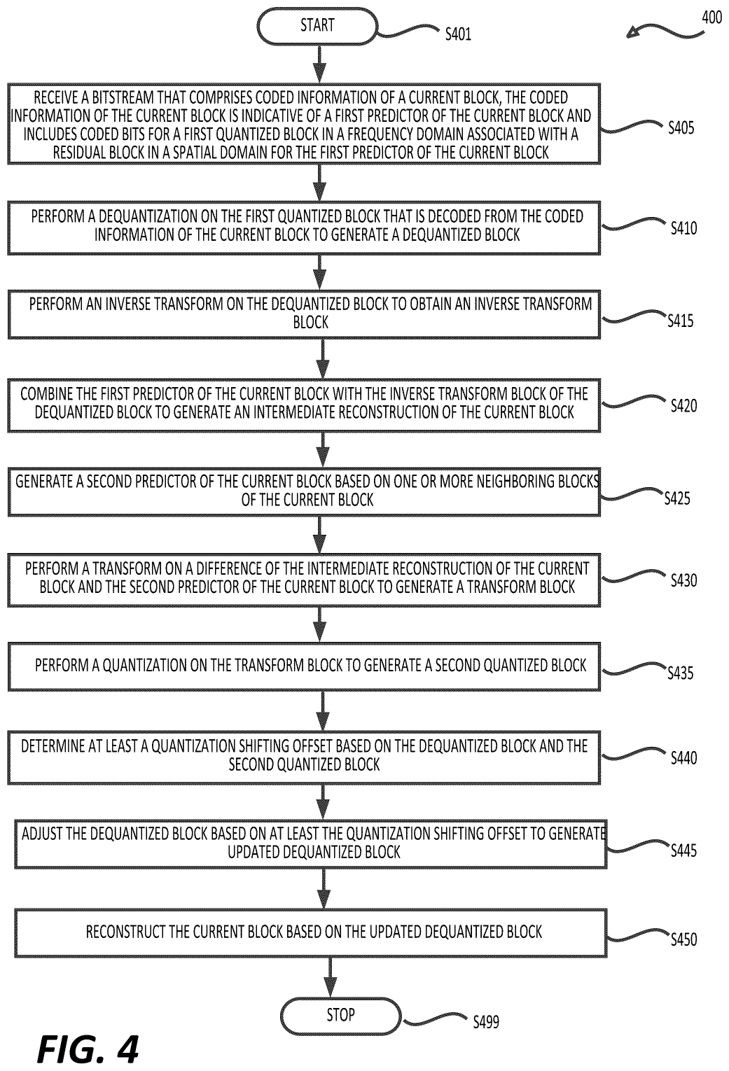

FIG. 4 shows a flow chart outlining a process (400) according to an aspect of the disclosure. The process (400) can be used in a video decoder. In various aspects, the process (400) is executed by processing circuitry, such as the processing circuitry that performs functions of the video decoder (110), the processing circuitry that performs functions of the video decoder (210), and the like. In some aspects, the process (400) is implemented in software instructions, thus when the processing circuitry executes the software instructions, the processing circuitry performs the process (400). The process starts at (S401) and proceeds to (S405).

At (S405), a bitstream that comprises coded information of a current block is received. The coded information of the current block is indicative of a first predictor of the current block and the coded information of the current block includes coded bits for a first quantized block in a frequency domain corresponding to a residual block in a spatial domain for the first predictor of the current block.

At (S410), a dequantization is performed on the first quantized block that is decoded from the coded information of the current block to generate a dequantized block.

At (S415), an inverse transform is applied on the dequantized block to obtain an inverse transform block.

At (S420), the first predictor of the current block is combined with the inverse transform block of the dequantized block to generate an intermediate reconstruction of the current block.

At (S425), a second predictor of the current block is generated based on one or more neighboring blocks of the current block.

At (S430), a transform is performed on a difference of the intermediate reconstruction of the current block and the second predictor of the current block to generate a transform block.

At (S435), a quantization is performed on the transform block to generate a second quantized block.

At (S440), at least a quantization shifting offset is determined based on the dequantized block and the second quantized block.

At (S445), the dequantized block is adjusted based on at least the quantization shifting offset to generate an updated dequantized block.

At (S450), the current block is reconstructed based on the updated dequantized block. For example, the updated dequantized block is inverse transformed to generate a updated residual block, and the updated residual block is combined with the first predictor for the reconstruction.

According to an aspect of the disclosure, the first quantized block and the second quantized block are quantized based on a same quantization step size.

In some examples, the second predictor of the current block is generated based on prediction information of a neighboring block that is above the current block.

In some examples, the second predictor of the current block is generated based on prediction information of a neighboring block that is left to the current block.

In some examples, a plurality of component predictors of the current block are generated respectively based on a plurality of neighboring blocks of the current block, and the second predictor is determined based on the plurality of component predictors. In an example, the second predictor is calculated as an average of the plurality of component predictors. In another example, the second predictor is calculated as a weighted average of the plurality of component predictors. For example, a specific component predictor that is generated based on a specific neighboring block of the current block is weighted based on a distance between the specific neighboring block and the current block.

In some examples, a plurality of component quantization shifting offsets respectively associated with a plurality of neighboring blocks of the current block are determined. The quantization shifting offset is calculated as an average of the plurality of component quantization shifting offsets.

In some examples, a plurality of component quantization shifting offsets respectively associated with a plurality of neighboring blocks of the current block are determined, and the quantization shifting offset is calculated as a weighted average of the plurality of component quantization shifting offsets.

In some examples, a specific component quantization shifting offset in the plurality of component quantization shifting offsets associated with a specific neighboring block of the current block is weighted based on a distance between the specific neighboring block and the current block.

In some examples, an intra mode for the current block is determined based on reconstructed samples in the one or more neighboring blocks of the current block. The second predictor of the current block is determined according to the intra mode no matter whether the first predictor is an intra predictor or an inter predictor.

In some examples, when the first predictor of the current block is predicted from an intra prediction, the second predictor is generated using a different intra mode from the first predictor.

In some examples, the transform is of a same type as an encoder side transform that is applied on the residual block to transform the residual block from the spatial domain to the frequency domain.

In some examples, the transform is of a different type from an encoder side transform that is applied on the residual block to transform the residual block from the spatial domain to the frequency domain.

In some examples, the quantization is a rate distortion optimization (RDO) based quantizer that is applied on the transform block to generate a second quantized block.

In some examples, a block level quantization shifting offset is determined according to one or more quantization shifting offsets for one or more coefficients in the transform block, and one or more coefficients of the dequantized block are determined based on the block level quantization shifting offset to generate updated dequantized block.

In some examples, a filter is applied on the intermediate reconstruction of the current block before using the intermediate reconstruction for a further processing.

Then, the process proceeds to (S499) and terminates.

The process (400) can be suitably adapted. Step(s) in the process (400) can be modified and/or omitted. Additional step(s) can be added. Any suitable order of implementation can be used.

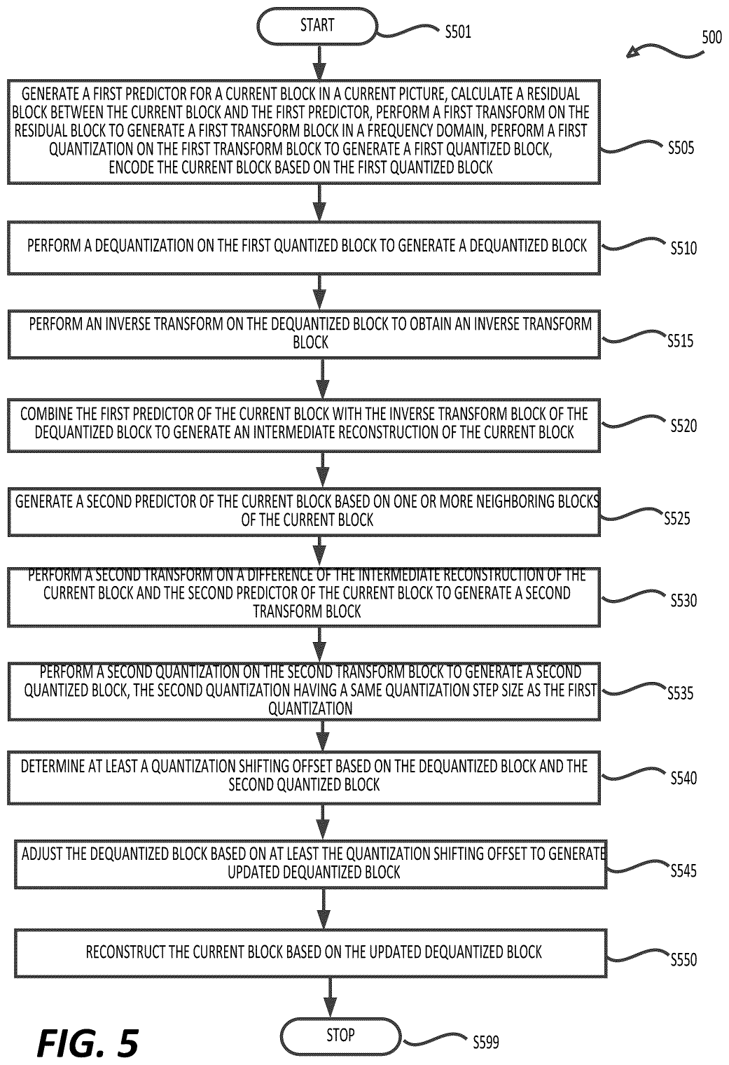

FIG. 5 shows a flow chart outlining a process (500) according to an aspect of the disclosure. The process (500) can be used in a video encoder. In various aspects, the process (500) is executed by processing circuitry, such as the processing circuitry that performs functions of the video encoder (103), the processing circuitry that performs functions of the video encoder (303), and the like. In some examples, the process (500) is implemented in software instructions, thus when the processing circuitry executes the software instructions, the processing circuitry performs the process (500). The process starts at (S501) and proceeds to (S505).

At (S505), to encode a current block by decoder quantization shifting offset derivation is determined. A first predictor for a current block in a current picture is determined. The first predictor can be inter prediction predictor or can be intra prediction predictor. A residual block between the current block and the first predictor is calculated. A first transform is applied on the residual block to generate a first transform block in a frequency domain, a first quantization is performed on the first transform block to generate a first quantized block. The current block is encoded based on the first quantized block.

At (S510), a dequantization is performed on the first quantized block to generate a dequantized block.

At (S515), an inverse transform is applied on the dequantized block to obtain an inverse transform block.

At (S520), the first predictor of the current block is combined with the inverse transform block of the dequantized block to generate an intermediate reconstruction of the current block.

At (S525), a second predictor of the current block is generated based on one or more neighboring blocks of the current block.

At (S530), a second transform is performed on a difference of the intermediate reconstruction of the current block and the second predictor of the current block to generate a second transform block.

At (S535), a second quantization is performed on the second transform block to generate a second quantized block, the second quantization has a same quantization step size as the first quantization.

At (S540), at least a quantization shifting offset is determined based on the dequantized block and the second quantized block.

At (S545), the dequantized block is adjusted based on at least the quantization shifting offset to generate an updated dequantized block.

At (S550), the current block is reconstructed based on the updated dequantized block. For example, the updated dequantized block is inverse transformed to generate a updated residual block, and the updated residual block is combined with the first predictor for the reconstruction.

According to an aspect of the disclosure, the first quantization that generates the first quantized block and the second quantization that generates the second quantized block are of a same quantization step size.

In some examples, the second predictor of the current block is generated based on prediction information of a neighboring block that is above the current block.

In some examples, the second predictor of the current block is generated based on prediction information of a neighboring block that is left to the current block.

In some examples, a plurality of component predictors of the current block are generated respectively based on a plurality of neighboring blocks of the current block, and the second predictor is determined based on the plurality of component predictors. In an example, the second predictor is calculated as an average of the plurality of component predictors. In another example, the second predictor is calculated as a weighted average of the plurality of component predictors. For example, a specific component predictor that is generated based on a specific neighboring block of the current block is weighted based on a distance between the specific neighboring block and the current block.

In some examples, a plurality of component quantization shifting offsets respectively associated with a plurality of neighboring blocks of the current block are determined. The quantization shifting offset is calculated as an average of the plurality of component quantization shifting offsets.

In some examples, a plurality of component quantization shifting offsets respectively associated with a plurality of neighboring blocks of the current block are determined, and the quantization shifting offset is calculated as a weighted average of the plurality of component quantization shifting offsets.

In some examples, a specific component quantization shifting offset in the plurality of component quantization shifting offsets associated with a specific neighboring block of the current block is weighted based on a distance between the specific neighboring block and the current block.

In some examples, an intra mode for the current block is determined based on reconstructed samples in the one or more neighboring blocks of the current block. The second predictor of the current block is determined according to the intra mode no matter whether the first predictor is an intra predictor or an inter predictor.

In some examples, when the first predictor of the current block is predicted from an intra prediction, the second predictor is generated using a different intra mode from the first predictor.

In some examples, the second transform is of a same type as the first transform that is applied on the residual block to transform the residual block from the spatial domain to the frequency domain.

In some examples, the second transform is of a different type from the first transform that is applied on the residual block to transform the residual block from the spatial domain to the frequency domain.

In some examples, the second quantization is a rate distortion optimization (RDO) based quantizer that is applied on the second transform block to generate a second quantized block.

In some examples, a block level quantization shifting offset is determined according to one or more quantization shifting offsets for one or more coefficients in the transform block, and one or more coefficients of the dequantized block are determined based on the block level quantization shifting offset to generate updated dequantized block.

In some examples, a filter is applied on the intermediate reconstruction of the current block before using the intermediate reconstruction for a further processing.

Then, the process proceeds to (S599) and terminates.

The process (500) can be suitably adapted. Step(s) in the process (500) can be modified and/or omitted. Additional step(s) can be added. Any suitable order of implementation can be used.

According to an aspect of the disclosure, a method of processing visual media data is provided. In the method, a bitstream of visual media data is processed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, the bitstream includes coded information of a current block, the coded information of the current block is indicative of a first predictor of the current block and includes coded bits for a first quantized block in a frequency domain associated with a residual block of the current block to the first predictor. The format rule specifies that a dequantization is performed on the first quantized block to generate a dequantized block, an inverse transform is performed on the dequantized block to obtain an inverse transform block, the first predictor of the current block is combined with the inverse transform block of the dequantized block to generate an intermediate reconstruction of the current block, a second predictor of the current block is generated based on one or more neighboring blocks of the current block, a transform is performed on a difference of the intermediate reconstruction of the current block and the second predictor of the current block to generate a transform block, a quantization is performed on the transform block to generate a second quantized block, the first quantized block and the second quantized block having a same quantization step size, at least a quantization shifting offset is determined based on the dequantized block and the second quantized block, the dequantized block is adjusted based on at least the quantization shifting offset to generate updated dequantized block, and the current block is reconstructed based on the updated dequantized block.

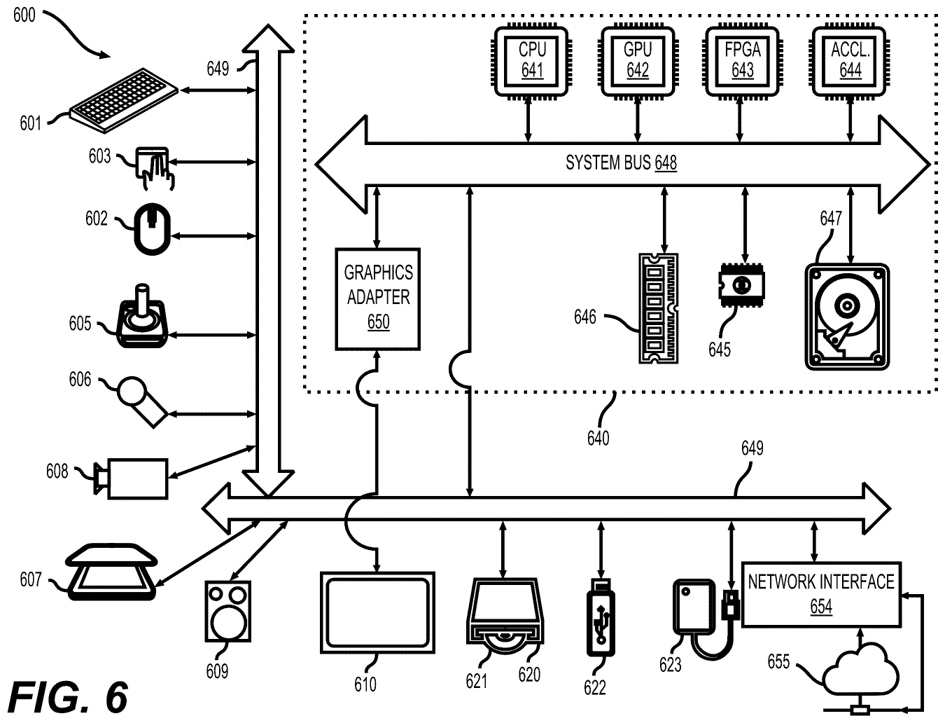

The techniques described above, can be implemented as computer software using computer-readable instructions and physically stored in one or more computer-readable media. For example, FIG. 6 shows a computer system (600) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 6 for computer system (600) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (600).

Computer system (600) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (601), mouse (602), trackpad (603), touch screen (610), data-glove (not shown), joystick (605), microphone (606), scanner (607), camera (608).

Computer system (600) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (610), data-glove (not shown), or joystick (605), but there can also be tactile feedback devices that do not serve as input devices), audio output devices (such as: speakers (609), headphones (not depicted)), visual output devices (such as screens (610) to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system (600) can also include human accessible storage devices and their associated media such as optical media including CD/DVD ROM/RW (620) with CD/DVD or the like media (621), thumb-drive (622), removable hard drive or solid state drive (623), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (600) can also include an interface (654) to one or more communication networks (655). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (649) (such as, for example USB ports of the computer system (600)); others are commonly integrated into the core of the computer system (600) by attachment to a system bus as described below (for example Ethernet interface into a PC computer system or cellular network interface into a smartphone computer system). Using any of these networks, computer system (600) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (640) of the computer system (600).

The core (640) can include one or more Central Processing Units (CPU) (641), Graphics Processing Units (GPU) (642), specialized programmable processing units in the form of Field Programmable Gate Areas (FPGA) (643), hardware accelerators for certain tasks (644), graphics adapters (650), and so forth. These devices, along with Read-only memory (ROM) (645), Random-access memory (646), internal mass storage such as internal non-user accessible hard drives, SSDs, and the like (647), may be connected through a system bus (648). In some computer systems, the system bus (648) can be accessible in the form of one or more physical plugs to enable extensions by additional CPUs, GPU, and the like. The peripheral devices can be attached either directly to the core's system bus (648), or through a peripheral bus (649). In an example, the screen (610) can be connected to the graphics adapter (650). Architectures for a peripheral bus include PCI, USB, and the like.

CPUs (641), GPUs (642), FPGAs (643), and accelerators (644) can execute certain instructions that, in combination, can make up the aforementioned computer code. That computer code can be stored in ROM (645) or RAM (646). Transitional data can also be stored in RAM (646), whereas permanent data can be stored for example, in the internal mass storage (647). Fast storage and retrieve to any of the memory devices can be enabled through the use of cache memory, that can be closely associated with one or more CPU (641), GPU (642), mass storage (647), ROM (645), RAM (646), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (600), and specifically the core (640) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (640) that are of non-transitory nature, such as core-internal mass storage (647) or ROM (645). The software implementing various aspects of the present disclosure can be stored in such devices and executed by core (640). A computer-readable medium can include one or more memory devices or chips, according to particular needs. The software can cause the core (640) and specifically the processors therein (including CPU, GPU, FPGA, and the like) to execute particular processes or particular parts of particular processes described herein, including defining data structures stored in RAM (646) and modifying such data structures according to the processes defined by the software. In addition or as an alternative, the computer system can provide functionality as a result of logic hardwired or otherwise embodied in a circuit (for example: accelerator (644)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A non-transitory computer-readable storage medium storing instructions which when executed by a processor cause the processor to perform an encoding method, the encoding method comprising:
determining to use a decoder quantization shifting offset derivation for encoding a current block;
generating a first predictor for the current block;
calculating a residual block between the current block and the first predictor;
performing a first transform on the residual block to generate a first transform block in a frequency domain;
performing a first quantization on the first transform block to generate a first quantized block;
encoding the current block into coded information in a bitstream based on the first quantized block;
performing a dequantization on the first quantized block to generate a dequantized block;
performing an inverse transform on the dequantized block to obtain an inverse transform block;
combining the first predictor of the current block with the inverse transform block of the dequantized block to generate an intermediate reconstruction of the current block;
generating a second predictor of the current block based on one or more neighboring blocks of the current block;
performing a second transform on a difference of the intermediate reconstruction of the current block and the second predictor of the current block to generate a second transform block;
performing a second quantization on the second transform block to generate a second quantized block, the second quantization having a same quantization step size as the first quantization;
determining at least a quantization shifting offset based on the dequantized block and the second quantized block;
adjusting the dequantized block based on at least the quantization shifting offset to generate updated dequantized block;
reconstructing the current block based on the updated dequantized block;
encoding a plurality of picture into the coded information in the bitstream based on the reconstructed current block; and
transmitting the bitstream.

2. An apparatus for video decoding, comprising processing circuitry configured to:
receive a bitstream that comprises coded information of a current block, the coded information of the current block being indicative of a first predictor of the current block and the coded information of the current block comprising coded bits for a first quantized block in a frequency domain associated with a residual block in a spatial domain for the first predictor of the current block;
perform a dequantization on the first quantized block that is decoded from the coded information of the current block to generate a dequantized block;
perform an inverse transform on the dequantized block to obtain an inverse transform block;
combine the first predictor of the current block with the inverse transform block of the dequantized block to generate an intermediate reconstruction of the current block;
generate a second predictor of the current block based on one or more neighboring blocks of the current block;
perform a transform on a difference of the intermediate reconstruction of the current block and the second predictor of the current block to generate a transform block;
perform a quantization on the transform block to generate a second quantized block;
determine at least a quantization shifting offset based on the dequantized block and the second quantized block;
adjust the dequantized block based on at least the quantization shifting offset to generate updated dequantized block; and
reconstruct the current block based on the updated dequantized block.

3. The apparatus of claim 2, wherein the first quantized block and the second quantized block have a same quantization step size.

4. The apparatus of claim 2, wherein the processing circuitry is configured to perform at least one of:
generating the second predictor of the current block based on prediction information of a neighboring block that is above the current block; and
generating the second predictor of the current block based on prediction information of a neighboring block that is left to the current block.

5. The apparatus of claim 2, wherein the processing circuitry is configured to:
generate a plurality of component predictors of the current block respectively based on a plurality of neighboring blocks of the current block; and
determine the second predictor based on an average of the plurality of component predictors or a weighted average of the plurality of component predictors.

6. The apparatus of claim 2, wherein the processing circuitry is configured to:
determine a plurality of component quantization shifting offsets respectively associated with a plurality of neighboring blocks of the current block; and
calculate the quantization shifting offset as an average of the plurality of component quantization shifting offsets or a weighted average of the plurality of component quantization shifting offsets.

7. The apparatus of claim 5, wherein a weight for a specific neighboring block of the current block is determined based on a distance between the specific neighboring block and the current block.

8. The apparatus of claim 2, wherein the processing circuitry is configured to:
derive an intra mode for the current block based on reconstructed samples in the one or more neighboring blocks of the current block; and
generate the second predictor of the current block according to the intra mode.

9. The apparatus of claim 2, wherein the processing circuitry is configured to:
when the first predictor of the current block is predicted from an intra prediction, generate the second predictor using a different intra mode from the first predictor.

10. The apparatus of claim 2, wherein the transform is of a same type as an encoder side transform that is applied on the residual block to transform the residual block from the spatial domain to the frequency domain.

11. The apparatus of claim 2, wherein the transform is of a different type from an encoder side transform that is applied on the residual block to transform the residual block from the spatial domain to the frequency domain.

12. The apparatus of claim 2, wherein the processing circuitry is configured to:
perform the quantization that is a rate distortion optimization (RDO) based quantizer on the transform block to generate a second quantized block.

13. The apparatus of claim 2, wherein the processing circuitry is configured to:
determine a block level quantization shifting offset according to one or more quantization shifting offsets for one or more coefficients in the transform block; and
adjust one or more coefficients of the dequantized block based on the block level quantization shifting offset to generate updated dequantized block.

14. The apparatus of claim 2, wherein the processing circuitry is configured to:
apply a filter on the intermediate reconstruction of the current block before using the intermediate reconstruction for a further processing.

15. A method for video encoding, comprising:
determining to use a decoder quantization shifting offset derivation for encoding a current block;
generating a first predictor for the current block;
calculating a residual block between the current block and the first predictor;
performing a first transform on the residual block to generate a first transform block in a frequency domain;
performing a first quantization on the first transform block to generate a first quantized block;
encoding the current block into coded information in a bitstream based on the first quantized block;
performing a dequantization on the first quantized block to generate a dequantized block;
performing an inverse transform on the dequantized block to obtain an inverse transform block;
combining the first predictor of the current block with the inverse transform block of the dequantized block to generate an intermediate reconstruction of the current block;
generating a second predictor of the current block based on one or more neighboring blocks of the current block;
performing a second transform on a difference of the intermediate reconstruction of the current block and the second predictor of the current block to generate a second transform block;
performing a second quantization on the second transform block to generate a second quantized block, the second quantization having a same quantization step size as the first quantization;
determining at least a quantization shifting offset based on the dequantized block and the second quantized block;
adjusting the dequantized block based on at least the quantization shifting offset to generate updated dequantized block;
reconstructing the current block based on the updated dequantized block; and
encoding a plurality of picture into the coded information in the bitstream based on the reconstructed current block.

16. The method of claim 15, wherein the first quantized block and the second quantized block have a same quantization step size.

17. The method of claim 15, wherein the generating the second predictor comprises at least one of:
generating the second predictor of the current block based on prediction information of a neighboring block that is above the current block; and
generating the second predictor of the current block based on prediction information of a neighboring block that is left to the current block.

18. The method of claim 15, wherein the generating the second predictor comprises:
generating a plurality of component predictors of the current block respectively based on a plurality of neighboring blocks of the current block; and
determining the second predictor based on an average of the plurality of component predictors or a weighted average of the plurality of component predictors.

19. The method of claim 15, wherein the determining the quantization shifting offset comprises:
determining a plurality of component quantization shifting offsets respectively associated with a plurality of neighboring blocks of the current block; and
calculating the quantization shifting offset as an average of the plurality of component quantization shifting offsets or a weighted average of the plurality of component quantization shifting offsets.

20. The method of claim 18, wherein a weight for a specific neighboring block of the current block is determined based on a distance between the specific neighboring block and the current block.
